(19) United States
(12) Patent Application Publication
(10) Pub. No.: US 2025/0038597 A1
(43) Pub. Date: Jan. 30, 2025

(54) ROTOR, MOTOR, AND METHOD FOR MANUFACTURING ROTOR

(71) Applicant: NIDEC CORPORATION, Kyoto (JP)

(72) Inventors: Mitsuhiro TAKEMOTO, Kyoto (JP); Masahiro SHIRAISHI, Kyoto (JP)

(21) Appl. No.: 18/779,431

(22) Filed: Jul. 22, 2024

(30) Foreign Application Priority Data
Jul. 28, 2023 (JP) 2023-122978

(51) Int. Cl. H02K 1/2791; H02K 1/30; H02K 15/03; H02K 21/22

(52) U.S. Cl. CPC H02K 1/2791; H02K 1/30; H02K 15/03; H02K 21/22

(57) ABSTRACT

A rotor rotatable about a central axis extending in an axial direction includes a yoke that is a cylindrical magnetic body extending in the axial direction. A plurality of ridge portions of the yoke are connected to one axial end of the yoke cylindrical portion in a cylindrical shape and extending in the axial direction, and are arranged at intervals in the circumferential direction. In each ridge portion, a protrusion protrudes radially inward from one axial end of the yoke cylindrical portion. Further, an extension extends in the other axial direction from the radially inner end of the protrusion along the radially inner surface of the yoke cylindrical portion. A magnet is located between the extensions adjacent to each other in the circumferential direction. The ridge portion is integral with the yoke cylindrical portion to define a single structure.

### CROSS-REFERENCE TO RELATED APPLICATIONS

The present application claims priority under 35 U.S.C. § 119 to Japanese Patent Application No. 2023-122978, filed on Jul. 28, 2023, the entire contents of which are hereby incorporated herein by reference.

### 1. Field of the Invention

The present disclosure relates to rotors, motors, and methods for manufacturing rotors.

### 2. Background

Conventionally, a motor including a rotor in which a plurality of magnets are arranged in a circumferential direction is known. For example, a rotor has a magnet holder in which two annular portions separated in the axial direction are connected by a plurality of supports.

However, when a holder dedicated to positioning a magnet is arranged on the rotor, the structure of the rotor becomes complicated and the number of parts increases. Therefore, there is a possibility that workability of assembly is deteriorated.

### SUMMARY

An example embodiment of a rotor of the present disclosure is rotatable about a central axis extending in the axial direction. The rotor includes a yoke. The yoke is a cylindrical magnetic body extending in the axial direction. Magnets arranged in the circumferential direction are located on a radially inner surface of the yoke. The yoke includes a yoke cylindrical portion in a cylindrical shape and a ridge portion. The yoke cylindrical portion extends in the axial direction. The ridge portions are located on one axial end of the yoke cylindrical portion, and are arranged at intervals in the circumferential direction. Each of the ridge portions includes a protrusion and an extension. The protrusion protrudes radially inward from one axial end of the yoke cylindrical portion. The extension extends in the other axial direction from a radially inner end of the protrusion along a radially inner surface of the yoke cylindrical portion. The magnets are located between the extensions adjacent to each other in the circumferential direction. The ridge portion is integral with the yoke cylindrical portion to define a single structure.

An example embodiment f a motor of the present disclosure includes the rotor as described above.

In an example embodiment of a method for manufacturing a rotor of the present disclosure, a rotor that is rotatable about a central axis extending in the axial direction is manufactured. In the rotor, a plurality of extensions are arranged side by side at intervals in the circumferential direction. The extension extends in the axial direction with respect to a radially inner surface of the yoke cylindrical portion extending in the axial direction. At the same time, a magnet is located between the extensions adjacent to each other in the circumferential direction. A method for manufacturing the rotor includes a step of forming the extensions by bending a plurality of column portions protruding from one axial end of the yoke cylindrical portion and arranged in the circumferential direction at intervals, with a root of each column portion as a fulcrum.

The above and other elements, features, steps, characteristics and advantages of the present disclosure will become more apparent from the following detailed description of the example embodiments with reference to the attached drawings.

### BRIEF DESCRIPTION OF THE DRAWINGS

FIG. 1 is a cross-sectional view illustrating a schematic configuration example of a motor according to an example embodiment of the present disclosure.

FIG. 2 is a perspective view of a rotor according to an example embodiment of the present disclosure.

FIG. 3 is an exploded perspective view of the rotor.

FIG. 4 is a flowchart explaining an example of a method for manufacturing a rotor according to an example embodiment of the present disclosure.

FIG. 5A is a schematic view illustrating an example of a step of forming a plate-shaped portion from a plate-shaped magnetic body according to an example embodiment of the present disclosure.

FIG. 5B is a schematic view illustrating an example of a step of forming a yoke cylindrical portion by drawing a plate-shaped portion.

FIG. 5C is a schematic view illustrating an example of a step of arranging an extension on a radially inner surface of the yoke cylindrical portion by folding of a column portion.

FIG. 6 is a flowchart explaining an example of another method for manufacturing a rotor according to an example embodiment of the present disclosure.

FIG. 7A is a schematic view illustrating an example of a step of forming another plate-shaped portion from a plate-shaped magnetic body.

FIG. 7B is a schematic view illustrating an example of a step of forming a yoke cylindrical portion by bending a plate-shaped portion.

FIG. 7C is a schematic view illustrating an example of a step of arranging an extension on a radially inner surface of the yoke cylindrical portion by folding of a column portion.

### DETAILED DESCRIPTION

Example embodiments will be described with reference to

the drawings hereinafter.

In the present specification, in a motor 100, a direction parallel to a central axis CA is referred to as an “axial direction”, “axial”, or “axially”. In the axial directions, a direction from a rotor 1 to a base part 31 to be described later is referred to as an “one axial direction Da”, and a direction from the base part 31 to the rotor 1 is referred to as “the other axial direction Db”. A direction orthogonal to the central axis CA is referred to as a “radial direction”, and a rotation direction around the central axis CA is referred to as a “circumferential direction”. Of the radial directions, a direction approaching the central axis CA is referred to as “radially inward”, and a direction away from the central axis CA is referred to as “radially outward”.

Further, in the present description, an “annular shape” includes not only a shape continuously connected without any cut along the entire circumference in the circumferential direction around the central axis CA but also a shape having one or more cuts in a part of the entire circumference around the central axis CA. Further, an “annular shape” also includes a shape having a closed curve around the central axis CA on a curved surface that intersects the central axis CA.

Further, in a positional relationship between any of an azimuth, a line, and a plane and another one of them, the term “parallel” includes not only a state in which they do not intersect even if they extend endlessly but also a state in which they are substantially parallel. In addition, “perpendicular” and “orthogonal” include not only a state in which both of them intersect each other at 90 degrees, but also a state in which they are substantially perpendicular and a state in which they are substantially orthogonal. That is, each of the terms “parallel”, “perpendicular”, and “orthogonal” includes a state in which a positional relationship between them has an angular deviation that does not depart from the gist of the present disclosure.

Note that, these terms are names used merely for description, and are not intended to limit actual positional relationships, directions, names, and the like.

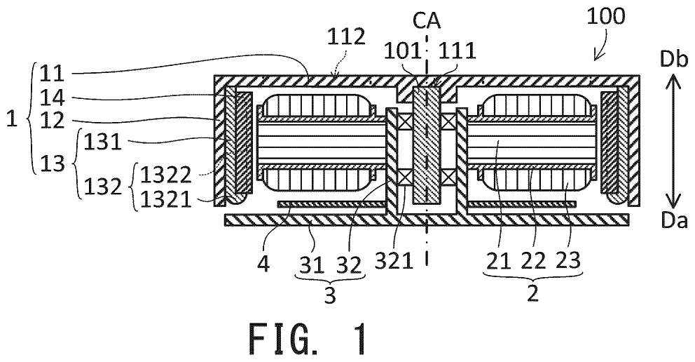

FIG. 1 is a cross-sectional view illustrating a schematic configuration example of the motor 100. FIG. 1 illustrates a sectional structure in the case where the motor 100 is virtually cut along a plane including the central axis CA and parallel to the axial direction.

As shown in FIG. 1, the motor 100 includes a shaft 101, a rotor 1, a stator 2, a housing 3, and a circuit board 4. According to the motor 100, as will be described later, it is possible to provide the rotor 1 capable of positioning a magnet 14 with a simple and inexpensive configuration, and productivity of the rotor 1 can be improved. In addition, it is possible to suppress or prevent the magnet 14 from being disposed obliquely when viewed from the radial direction or prevent the magnets 14 adjacent to each other in the circumferential direction from coming into contact with each other.

The shaft 101 extends in the axial direction along the central axis CA and is rotatable about the central axis CA. That is, in the present example embodiment, the shaft 101 is a rotation axis. However, the present disclosure is not limited to this example. The shaft 101 may be a fixed shaft fixed together with the stator 2, or may not be rotatable about the central axis CA. In the case of a fixed shaft, a bearing that rotatably supports the rotor 1 with respect to the shaft 101 is arranged between the shaft 101 and the rotor 1.

The rotor 1 is rotatable about the central axis CA extending in the axial direction. The rotor 1 includes a rotor lid 11, a rotor cylindrical portion 12, a yoke 13, and a plurality of magnets 14.

The rotor lid 11 is fixed to one axial end of the shaft 101. As described above, the rotor 1 includes the rotor lid 11. The rotor lid 11 is disposed at the other axial direction Db side with respect to the stator 2, the yoke 13 (in particular, a ridge portion 132 to be described later), and the like, and expands in the radial direction.

In the present example embodiment, the rotor lid 11 has a hole 111 and an opening 112. The hole 111 is disposed on one axial end surface of the rotor lid 11 at the center in the radial direction of the rotor lid 11. In the present example embodiment, the hole 111 is a recess recessed in the other axial direction Db, but is not limited to this example, and may be a through hole extending in the axial direction. One axial end of the shaft 101 is inserted into and fixed to the hole 111. The plurality of openings 112 are opened toward the one axial direction Da and the other axial direction Db of the rotor lid 11, are arranged radially outward with respect to the hole 111, and are arranged in the circumferential direction.

The rotor cylindrical portion 12 has a cylindrical shape extending in the one axial direction Da from the radially outer end of the rotor lid 11. As described above, the rotor 1 includes the rotor cylindrical portion 12. The rotor cylindrical portion 12 surrounds the stator 2, the yoke 13, and the like.

The yoke 13 is disposed on the radially inner surface of the rotor cylindrical portion 12 and surrounds the stator 2. As described above, the rotor 1 includes the yoke 13. The yoke 13 is a cylindrical magnetic body extending in the axial direction. A plurality of magnets 14 arranged in the circumferential direction are disposed on a radially inner surface of the yoke 13.

The plurality of magnets 14 surround the stator 2 (in particular, a stator core 21 to be described later) and face each other in the radial direction. The plurality of magnets 14 are arranged at intervals in the circumferential direction. The magnetic poles (S pole, N pole) on the radially inner side of the magnets 14 adjacent to each other in the circumferential direction are alternately different.

Next, the stator 2 rotates the rotor 1 by the magnetic flux generated by energization. As illustrated in FIG. 1, the stator 2 includes the stator core 21, an insulator 22, and a coil 23.

In the stator core 21, a plurality of coils 23 arranged in the circumferential direction are disposed. The stator core 21 is an annular magnetic body surrounding the shaft 101, and in the present example embodiment, is a laminated body in which plate-shaped electromagnetic steel plates extending in the radial direction are laminated in the axial direction. The stator core 21 is fixed to a radially outer surface of a holder cylindrical portion 32 described later. In addition, the stator core 21 has slots (not illustrated). The plurality of slots penetrate the stator core 21 in the axial direction and are arranged in the circumferential direction.

The insulator 22 has electrical insulation, and is disposed on surfaces of the stator core 21 (particularly, both end surfaces in the axial direction, the inner surface of the slot, and the like).

The coil 23 is a member in which a conductive wire (reference numeral is omitted) is arranged in a coil shape on the stator core 21 via the insulator 22. The conductive wire is, for example, an enamel-coated copper wire, a metal wire coated with an electrically insulating member, or the like, and is wound around a tooth (not illustrated) between slots adjacent to each other in the circumferential direction of the stator core 21 to form the coil 23. When a drive current is supplied to each of the coils 23, the stator 2 is excited to drive the rotor 1.

Next, the housing 3 includes a base part 31 and a holder cylindrical portion 32. The base part 31 is disposed on the one axial direction Da side with respect to the stator 2 and expands in the radial direction. The holder cylindrical portion 32 has a cylindrical shape extending from the other axial end surface of the base part 31 in the other axial direction Db. The holder cylindrical portion 32 surrounds the shaft 101 and supports the stator core 21.

A bearing 321 is disposed on the inner peripheral surface (that is, the radially inner surface) of the holder cylindrical portion 32, and the shaft 101 is inserted therethrough. The holder cylindrical portion 32 rotatably supports the shaft 101 via the bearing 321. As the bearing 321, a rolling bearing such as a ball bearing, a sliding bearing, a fluid dynamic bearing, or the like can be adopted.

Next, the circuit board 4 is disposed on the one axial direction Da side with respect to the stator 2 and is supported by the holder cylindrical portion 32. In FIG. 1, the circuit board 4 expands radially outward from the radially outer surface of the holder cylindrical portion 32. The circuit board 4 is electrically connected to a lead wire (not illustrated) drawn out from the coil 23. A drive circuit of the stator 2 and the like are mounted on the circuit board 4. Further, an external wiring (not illustrated) is electrically connected to the circuit board 4. The external wiring is drawn out to the outside of the motor 100, and electrically connects the circuit board 4 to an external device, a power supply, and the like.

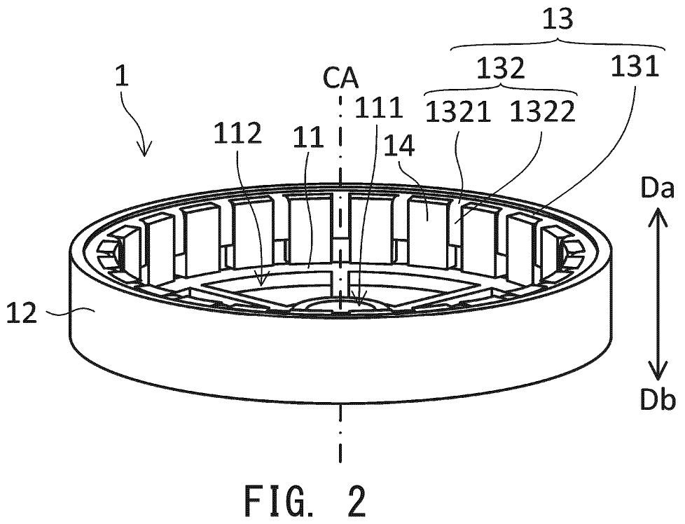

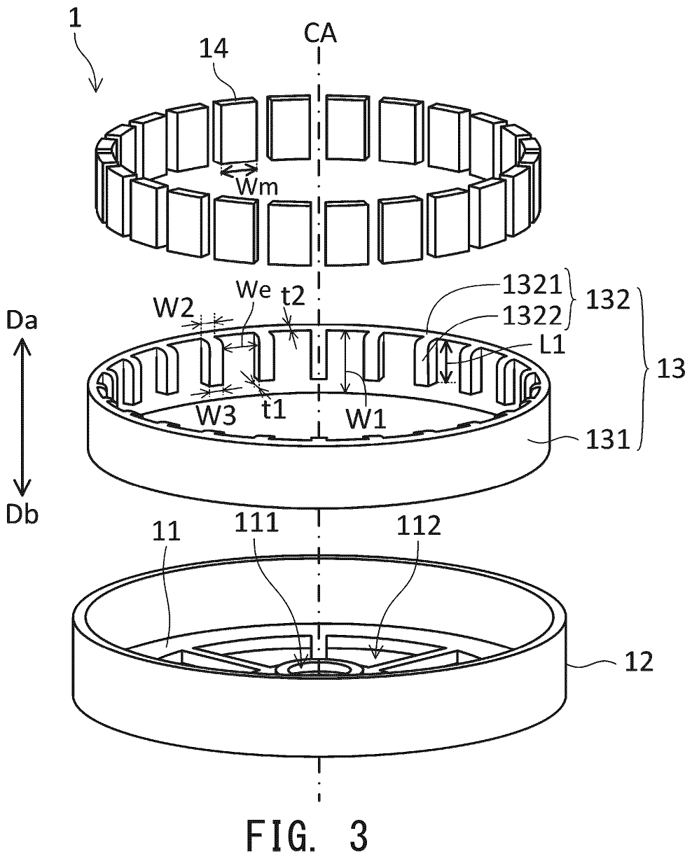

Next, a configuration example of the yoke 13 will be described with reference to FIGS. 1 to 3. FIG. 2 is a perspective view of the rotor 1. FIG. 3 is an exploded perspective view of the rotor 1. Note that in FIGS. 2 and 3, the directions of the one axial direction Da and the other axial direction Db on the sheet surfaces are opposite to those in FIG. 1.

As illustrated in FIGS. 1 to 3, the yoke 13 includes a yoke cylindrical portion 131 and ridge portions 132. The yoke cylindrical portion 131 has a cylindrical shape extending in the axial direction. The ridge portions 132 are connected to one axial end of the yoke cylindrical portion 131, and are arranged at intervals in the circumferential direction.

Each of the ridge portions 132 includes a protrusion 1321 and an extension 1322. The protrusion 1321 protrudes radially inward from one axial end of the yoke cylindrical portion 131. The extension 1322 extends in the other axial direction Db from the radially inner end of the protrusion 1321 along the radially inner surface of the yoke cylindrical portion 131. Preferably, the extension 1322 is disposed on the radially inner surface of the yoke cylindrical portion 131 in contact with the yoke cylindrical portion 131. However, this exemplification does not exclude a configuration in which the extension 1322 is not in contact with the radially inner surface of the yoke cylindrical portion 131 in the at least one ridge portion 132. For example, the extension 1322 may face the radially inner surface of the yoke cylindrical portion 131 1 in the radial direction with a gap therebetween.

On the radially inner surface of the yoke cylindrical portion 131, a plurality of extensions 1322 are arranged at intervals in the circumferential direction. In the present example embodiment, the plurality of extensions 1322 are arranged at equal intervals in the circumferential direction. The magnet 14 is inserted and fixed at this interval. That is, the magnet 14 is disposed between the extensions 1322 adjacent to each other in the circumferential direction. Note that an interval We between the extensions 1322 adjacent to each other in the circumferential direction is the same as a width Wm (for example, circumferential width) of the magnet 14 in the direction perpendicular to the axial direction and the radial direction as long as the magnet 14 can be arranged between the extensions 1322 adjacent to each other in the circumferential direction. However, the above-described example does not exclude a configuration in which the interval We between the extensions 1322 adjacent to each other in the circumferential direction is larger than the width Wm of the magnet 14 described above, and a configuration in which at least the plurality of extensions 1322 are arranged at different intervals in the circumferential direction.

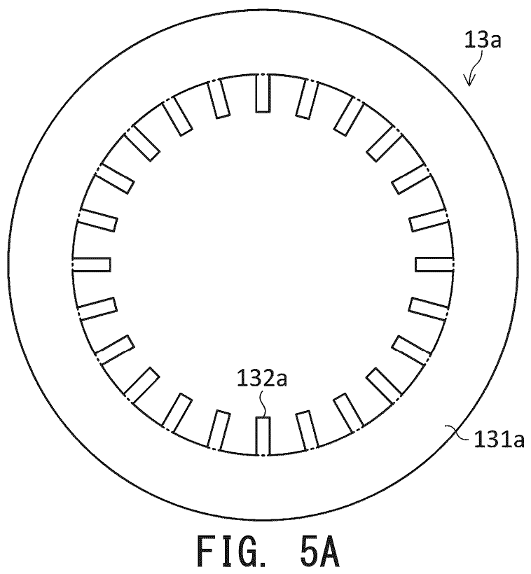

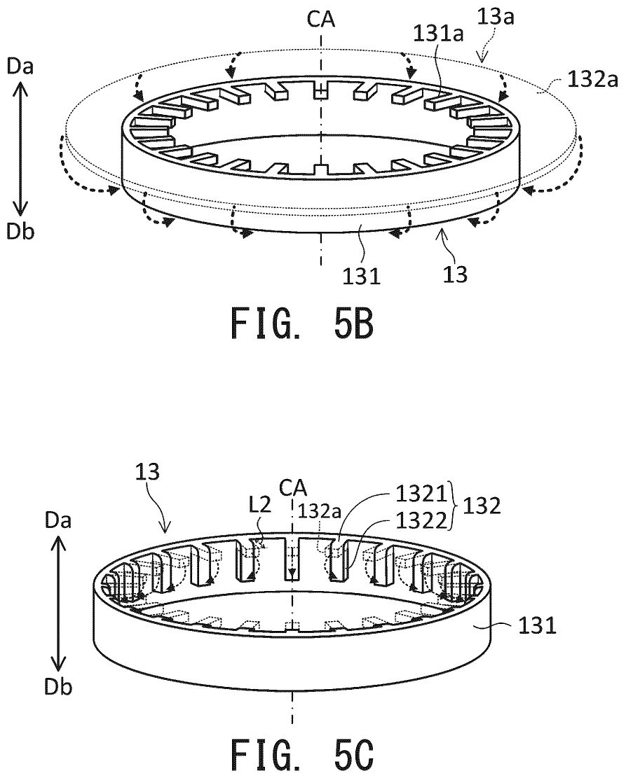

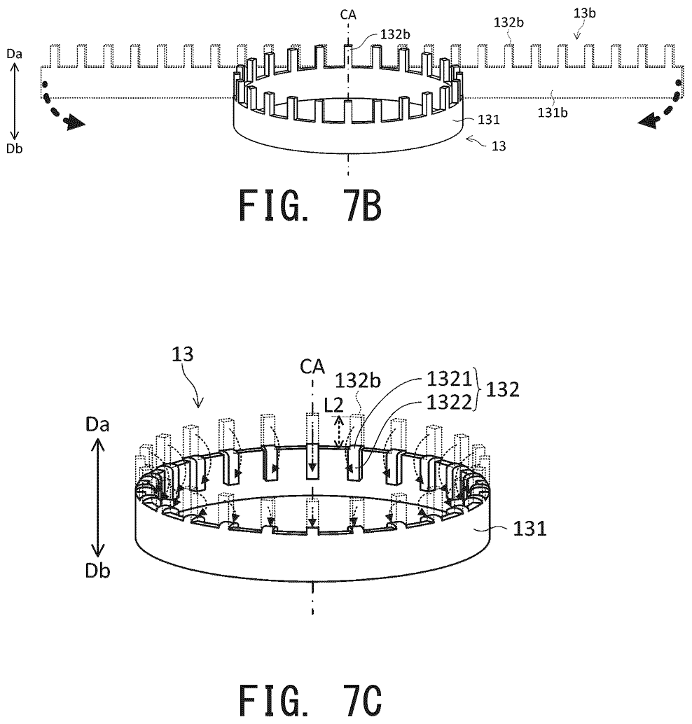

The ridge portion 132 is integrally formed with the yoke cylindrical portion 131 to define a single structure. Thus, the yoke cylindrical portion 131 and the plurality of ridge portions 132 protruding from one axial end thereof can be integrally formed as a single plate-shaped portion 13a (see FIGS. 5A and 7A described later) by, for example, pressing a plate-shaped magnetic body. The yoke cylindrical portion 131 is formed in a cylindrical shape, and the plurality of ridge portions 132 are arranged in the circumferential direction. Thereafter, each of the ridge portions 132 is bent from the base thereof and overlapped on the radially inner surface of the yoke cylindrical portion 131. As a result, the plurality of extensions 1322 extending in the axial direction can be easily arranged side by side in the circumferential direction on the radially inner surface of the yoke cylindrical portion 131, and the magnet 14 can be disposed between the extensions 1322 adjacent to each other in the circumferential direction. That is, the plurality of extensions 1322 can be easily and inexpensively disposed on the radially inner surface of the yoke cylindrical portion 131, as compared with a configuration in which the extensions 1322 are formed on the radially inner surface of the yoke cylindrical portion 131 by cutting or the like. Therefore, it is possible to provide the rotor 1 in which the magnets 14 can be positioned with a simple and inexpensive configuration, and the productivity of the rotor 1 can be improved. In addition, it is possible to suppress or prevent the magnet 14 from being disposed obliquely when viewed from the radial direction or prevent the magnets 14 adjacent to each other in the circumferential direction from coming into contact with each other.

The rotor cylindrical portion 12 surrounds the yoke cylindrical portion 131 and is in contact with the radially outer surface of the yoke cylindrical portion 131. The other axial end of the yoke cylindrical portion 131 is in contact with the rotor lid 11. Since the ridge portion 312 is folded from the one axial end to the radially inner surface of the yoke cylindrical portion 131, the yoke 13 can be easily attached to the rotor lid 11 and the rotor cylindrical portion 12 by inserting the other axial end of the yoke cylindrical portion 131 toward the rotor cylindrical portion 12 and abutting on the rotor lid 11. Moreover, by inserting the magnet 14 from the one axial direction Da side between the extensions 1322 adjacent to each other in the circumferential direction, the magnet 14 can be easily disposed on the radially inner side of the rotor cylindrical portion 12 and the yoke 13.

Preferably, the other axial end of the extension 1322 is disposed on the other axial direction Db side with respect to the one axial end of the yoke cylindrical portion 131 and on the one axial direction Da side with respect to the other axial end of the yoke cylindrical portion 131. That is, the other axial end of the extension 1322 does not reach one axial end of the yoke cylindrical portion 131. This means that an axial length L1 of the extension 1322 is equal to or less than an axial width W1 of the yoke cylindrical portion 131 (see FIG. 3). Thus, the axial length (that is, an axial length L2 of the column portions 132a and 132b in FIGS. 5A and 7A described later) of the ridge portion 132 before the protrusion 1321 is formed by bending can be shortened. Therefore, the number of yokes 13 (see FIGS. 5A to 5C and FIGS. 7A to 7C to be described later) that can be formed from one magnetic body can be further increased. Therefore, the production efficiency of the yoke 13 can be improved.

More preferably, the axial length L1 of the extension 1322 is equal to or larger than one third (W1/3) of the axial width of the yoke cylindrical portion 131, and is equal to or smaller than the axial width W1 of the yoke cylindrical portion 131. More preferably, the axial length L1 of the extension 1322 is equal to or larger than a half (W1/2) of the axial width of the yoke cylindrical portion 131 and is equal to or smaller than the axial width W1 of the yoke cylindrical portion 131. Accordingly, it is possible to prevent the magnet 14 disposed between the extensions 1322 adjacent to each other in the circumferential direction from being disposed obliquely as viewed from the radial direction. Therefore, the magnet 14 can be arranged with high accuracy.

When L1<(W1/2), there is a possibility that the magnet 14 is disposed obliquely as viewed from the radial direction. In addition, in a case of L1<(W1/3), this possibility is further increased.

When L1>W1, the other axial end of the extension 1322 protrudes in the other axial direction Db from the other axial end of the yoke cylindrical portion 131. Therefore, the other axial end of the extension 1322 comes into contact with another member (for example, the rotor lid 11) or the like, which may hinder the assembly of the rotor 1.

However, the above example does not exclude configurations where L1<(W1/2) (and the configuration where L1<(W1/3), and L1>W1.

Preferably, a radial thickness t1 of the extension 1322 is same as a radial thickness t2 of the yoke cylindrical portion 131. Thus, the yoke 13 in which the extension 1322 is disposed on the radially inner surface can be formed from one plate-shaped magnetic body without requiring a step of changing the thickness of the extension 1322 or the like. However, this example does not exclude a configuration in which t1≈t2 is not satisfied. For example, t1>t2 or t1<t2 may be satisfied.

In the present example embodiment, a circumferential width W2 of the protrusion 1321 is the same as a circumferential width W3 of the extension 1322 in each of the ridge portions 132. However, the present disclosure is not limited to this example, and in at least any one of the ridge portions 132, the circumferential width W2 of the protrusion 1321 may be smaller than the circumferential width W3 of the extension 1322. This configuration facilitates bending of the root of the ridge portion 132 protruding from the yoke cylindrical portion 131. Alternatively, in at least one of the ridge portions 132, the circumferential width W2 of the protrusion 1321 may be larger than the circumferential width W3 of the extension 1322. Accordingly, when the ridge portion 132 is bent, breakage of the ridge portion 132 from the root can be prevented. When W2>W3, the magnet 14 can be inserted and fixed between the extensions 1322 adjacent to each other in the circumferential direction from the radially inner side toward the radially outer side.

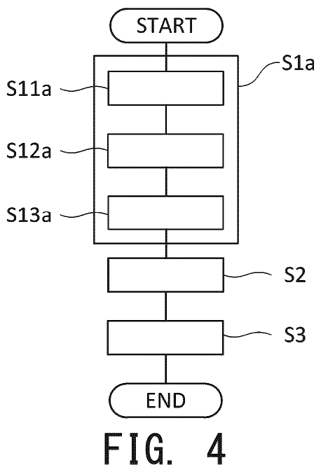

Next, an example of a method for manufacturing the rotor 1 will be described with reference to FIGS. 3 to 5C. FIG. 4 is a flowchart for explaining an example of a method for manufacturing the rotor 1. FIGS. 5A to 5C are schematic views illustrating a manufacturing process example of the yoke 13. FIG. 5A is a schematic view illustrating an example of a step of forming a plate-shaped portion 13a from a plate-shaped magnetic body. FIG. 5B is a schematic view illustrating an example of a step of forming a yoke cylindrical portion 131 by drawing the plate-shaped portion 13a. FIG. 5C is a schematic view illustrating an example of a step of arranging the extension 1322 on a radially inner surface of the yoke cylindrical portion 131 by folding of the column portion 132a.

In the method for manufacturing the rotor 1 illustrated in FIG. 4, the plurality of extensions 1322 extending in the axial direction with respect to the radially inner surface of the yoke cylindrical portion 131 are arranged side by side at intervals in the circumferential direction. The yoke cylindrical portion 131 is rotatable about a central axis CA extending in the axial direction, and extends in the axial direction. Furthermore, the magnet 14 is disposed between the extensions 1322 adjacent to each other in the circumferential direction.

First, the yoke 13 illustrated in FIG. 3 is formed (step S1a).

Specifically, as illustrated in FIG. 5A, the single plate-shaped portion 13a is formed from a plate-shaped magnetic body by punching by press working or the like (step S11a). The plate-shaped portion 13a integrally includes a disk portion 131a and a plurality of column portions 132a. The disk portion 131a has a disk shape having an opening at the center. The plurality of column portions 132a protrude radially inward from the inner edge of the disk portion 131a. Step S1a includes step S11a. The “radially inward” in which the column portion 132a protrudes is a direction approaching an axis corresponding to the central axis CA with reference to the axis. The axis extends in parallel with the normal direction of the plate-shaped portion 13a through the center of the opening of the disk portion 131a. The plurality of column portions 132a are arranged at equal intervals along the inner edge of the disk portion 131a.

Then, as illustrated in FIG. 5B, the disk portion 131a is formed into a cylindrical shape extending in the normal direction of the plate-shaped portion 13a by drawing by means of pressing (step S12a). As a result, the yoke cylindrical portion 131 surrounding the central axis CA is formed. Step S1a includes step S12a. In FIG. 5B, the column portion 132a protrudes radially inward from one axial end of the yoke cylindrical portion 131.

According to steps S11a and S12a, the disk portion 131a of the single plate-shaped portion 13a formed from a plate-shaped magnetic body can be made into a cylindrical shape by a simple and inexpensive process such as press working and drawing. In addition, the seamless yoke cylindrical portion 131 can be formed with high accuracy. Therefore, it is possible to efficiently form the cylindrical yoke 13 in which the yoke cylindrical portion 131 and the ridge portion 132 (the column portion 132a in FIG. 5B) are integral with each other to define a single structure.

Thereafter, as illustrated in FIG. 5C, each column portion 132a is folded in the other axial direction Db (step S13a). Specifically, the ridge portion 132 is formed by bending the column portion 132a with the root of the column portion 132a (the radially outer end of the column portion 132a in FIG. 5C) as a fulcrum. The column portions 132a protrude from one axial end of the yoke cylindrical portion 131 and are arranged in the circumferential direction at intervals. Step S1a includes step S13a.

According to step S13a, it is possible to provide the rotor 1 capable of positioning the magnet 14 with a simple and inexpensive configuration as compared with the configuration in which the extension 1322 is formed on the radially inner surface of the yoke cylindrical portion 131 by cutting or the like, and it is possible to improve the productivity of the rotor 1. In addition, it is possible to suppress or prevent the magnet 14 from being disposed obliquely when viewed from the radial direction or prevent the magnets 14 adjacent to each other in the circumferential direction from coming into contact with each other.

Next, the yoke 13 illustrated in FIG. 3 is attached to the inside of the covered cylindrical member including the rotor lid 11 and the rotor cylindrical portion 12 (step S2). In the present example embodiment, the yoke 13 is attached by press fitting. However, the method of attaching the yoke 13 is not limited to this example. For example, adhesion using an adhesive, screwing of a female screw portion formed on a radially inner surface of the rotor cylindrical portion 12 and a male screw formed on a radially outer surface of the yoke cylindrical portion 131, insert molding of the yoke 13, the rotor lid 11, the rotor cylindrical portion 12, and the like may be adopted.

Each of the magnets 14 is disposed between the circumferentially adjacent extensions 1322 of the yoke 13 (step S3). For example, the magnet 14 is inserted and fixed from the one axial direction Da side toward the other axial direction Db side between the extensions 1322 adjacent to each other in the circumferential direction. Alternatively, the magnet 14 may be inserted radially outward from the radially inner side between the extensions 1322 adjacent to each other in the circumferential direction. As a fixing means of the magnet 14, for example, press-fitting, adhesion using an adhesive, brazing using silver wax or the like can be adopted.

Thus, the manufacturing method of FIG. 4 is completed, and the rotor 1 illustrated in FIG. 2 can be manufactured.

Note that step S3 may be performed between steps Sla and S2. That is, the method for manufacturing the rotor 1 may be performed in the order of steps S1a, S3, and S2. For example, in step S2, the yoke 13 in a state where the magnets 14 are arranged between the extensions 1322 adjacent to each other in the circumferential direction may be attached to the inside of the covered cylindrical member including the rotor lid 11 and the rotor cylindrical portion 12.

Alternatively, steps S13a and S2 may be performed after step S3. That is, in the method for manufacturing the rotor 1, steps S11a, S12a, S3, S13a, and S2 may be performed in this order. For example, in step S3, the yoke 13 in the state illustrated in FIG. 5B may be attached to the inside of the covered cylindrical member including the rotor lid 11 and the rotor cylindrical portion 12. Thereafter, the column portions 132a may be folded over the radially inner surface of the yoke cylindrical portion 131 to arrange the extensions 1322 at intervals in the circumferential direction. Then each of the magnets 14 may be arranged between the extensions 1322 adjacent to each other in the circumferential direction.

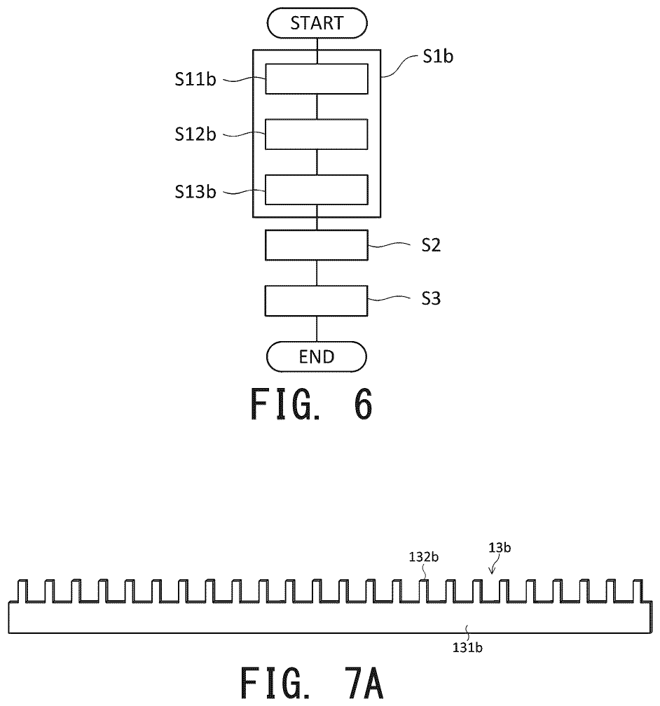

Next, an example of another method for manufacturing the rotor 1 will be described with reference to FIG. 3 and FIGS. 6 to 7C. FIG. 6 is a flowchart for explaining an example of another method for manufacturing the rotor 1. FIGS. 7A to 7C are schematic views illustrating another manufacturing process example of the yoke 13. FIG. 7A is a schematic view illustrating an example of a step of forming another plate-shaped portion 13b from a plate-shaped magnetic body. FIG. 7B is a schematic view illustrating an example of a step of forming a yoke cylindrical portion 131 by bending the plate-shaped portion 13b. FIG. 7C is a schematic view illustrating an example of a step of arranging the extension 1322 on a radially inner surface of the yoke cylindrical portion 131 by folding of the column portion 132b.

First, in another method for manufacturing the rotor 1 illustrated in FIG. 6, step S1b of forming the yoke 13 is different from that in FIG. 4.

Specifically, as illustrated in FIG. 7A, the single plate-shaped portion 13b is formed from a plate-shaped magnetic body by punching by press working or the like (step S11b). The plate-shaped portion 13b integrally includes a plate-shaped rectangular portion 131b and a plurality of column portions 132b. The plurality of column portions 132b protrude from one side of the outer edge portion of the rectangular portion 131b. Step S1b includes step S11b. The plurality of column portions 132b are arranged at equal intervals in a direction perpendicular to the normal direction of the rectangular portion 131b and the direction in which the column portions 132b extend.

Then, as illustrated in FIG. 7B, the rectangular portion 131b is bent into a cylindrical shape about an axis (that is, the central axis CA) parallel to the direction in which the column portion 132b extends (that is, axial direction) (step S12b). Thus, the yoke cylindrical portion 131 is formed. Step S1b includes step S12b.

According to steps S11b and S12b, the single plate-shaped portion 13b formed of the plate-shaped magnetic body can be bent into a cylindrical shape by a simple and inexpensive process such as press working. Therefore, it is possible to efficiently form the cylindrical yoke 13 in which the yoke cylindrical portion 131 and the ridge portion 132 (the column portion 132b in FIG. 7B) are integrally formed to define a single structure.

Thereafter, as illustrated in FIG. 7C, each of the column portions 132b is folded in the other axial direction Db via the radially inward (step S13b). Specifically, the ridge portion 132 is formed by bending the column portion 132b with the root of the column portion 132b (the other axial end of the column portion 132b in FIG. 7C) as a fulcrum. The column portions 132b protrude from one axial end of the yoke cylindrical portion 131 and are arranged in the circumferential direction at intervals. Step S1b includes step S13b.

According to step S13b, it is possible to provide the rotor 1 capable of positioning the magnet 14 with a simple and inexpensive configuration as compared with the configuration in which the extension 1322 is formed on the radially inner surface of the yoke cylindrical portion 131 by cutting or the like, and the productivity of the rotor 1 can be improved. In addition, it is possible to suppress or prevent the magnet 14 from being disposed obliquely when viewed from the radial direction or prevent the magnets 14 adjacent to each other in the circumferential direction from coming into contact with each other.

Note that subsequent steps (for example, steps S2 and S3) in FIG. 6 are the same as those in FIG. 4. Therefore, these descriptions are omitted.

The example embodiments of the present disclosure has been described above. It is to be noted that the scope of the present disclosure is not limited to the above-described example embodiments.

example embodiments described above will be collectively described below.

For example, the rotor disclosed in the present specification is a rotor rotatable about a central axis extending in an axial direction. The rotor includes a yoke that is a magnetic body having a cylindrical shape extending in the axial direction, the yoke including a plurality f magnets arranged in a circumferential direction and disposed on a radially inner surface. The yoke includes a yoke cylindrical portion in a cylindrical shape extending in the axial direction, and a plurality of ridge portions connected to one axial end of the yoke cylindrical portion and arranged at intervals in the circumferential direction. In this configuration, each of the ridge portions includes a protrusion protruding radially inward from the one axial end of the yoke cylindrical portion, and an extension extending from a radially inner end of the protrusion in another axial direction along a radially inner surface of the yoke cylindrical portion, each of the magnets is disposed between the extensions adjacent to each other in the circumferential direction, and the ridge portions are integral with the yoke cylindrical portion to define a single structure (first configuration).

The rotor having the first configuration may be configured such that the other axial end of the extension is disposed on the other axial direction side with respect to the one axial end of the yoke cylindrical portion, and on one axial direction side with respect to the other axial end of the yoke cylindrical portion (second configuration).

The rotor having the first or second configuration may be configured such that an axial length of the extension is equal to or larger than one third of an axial width of the yoke cylindrical portion, and is equal to or smaller than the axial width of the yoke cylindrical portion (third configuration).

The rotor having any one of the first to third configurations may be configured to further include a rotor lid disposed on the other axial direction side with respect to the ridge portion and expanding in the radial direction and a rotor cylindrical portion extending in one axial direction from a radially outer end of the rotor lid. In this configuration, the rotor cylindrical portion may surround the yoke cylindrical portion and may be in contact with a radially outer surface of the yoke cylindrical portion, and the other axial end of the yoke cylindrical portion may be in contact with the rotor lid (fourth configuration).

The rotor having any one of the first to fourth configurations may be configured such that a radial thickness of the extension is equal to or substantially equal to a radial thickness of the yoke cylindrical portion (fifth configuration).

The rotor having any one of the first to fifth configurations may be configured such that in at least any one of the ridge portions, a circumferential width of the protrusion is smaller than a circumferential width of the extension (sixth configuration). Further, the motor disclosed in the present specification is configured to include the rotor having any one of the first to sixth configurations (seventh configuration). The method for manufacturing a rotor disclosed in the present specification is a method for manufacturing a rotor rotatable about a central axis extending in an axial direction, the rotor including a plurality of extensions extending in the axial direction arranged side by side at intervals in a circumferential direction with respect to a radially inner surface of a yoke cylindrical portion extending in the axial direction, and a magnet arranged between the extensions adjacent to each other in the circumferential direction. The method is configured to include forming the extensions by bending a plurality of column portions protruding from one axial end of the yoke cylindrical portion and arranged in a circumferential direction at intervals, with a root of each column portion as a fulcrum (eighth configuration).

The method for manufacturing the rotor having the eighth configuration may be configured to further include forming a single plate-shaped portion from a plate-shaped magnetic body, the single plate-shaped portion integrally including a disk portion in a disk shape having an opening at a center and the column portions protruding radially inward from an inner edge of the disk portion, and forming the yoke cylindrical portion by shaping the disk portion into a cylindrical shape extending in a normal direction of the plate-shaped portion by drawing (ninth configuration).

The method for manufacturing the rotor having the eighth configuration may be configured to further include forming a single plate-shaped portion from a plate-shaped magnetic body, the single plate-shaped portion integrally including a rectangular or substantially rectangular portion in a plate shape and the column portions protruding from one side of an outer edge portion of the rectangular or substantially rectangular portion, and forming the yoke cylindrical portion by bending the rectangular portion into a cylindrical shape about an axis parallel to a direction in which the column portions extend (tenth configuration).

Example embodiments of the present disclosure are useful, for example, for devices including rotors including a plurality of magnets arranged in a circumferential direction.

Features of the above-described example embodiments and the modifications thereof may be combined appropriately as long as no conflict arises.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A rotor rotatable about a central axis extending in an axial direction, the rotor comprising:
a yoke that is a magnetic body with a cylindrical shape extending in the axial direction, the yoke including a plurality of magnets arranged in a circumferential direction and located on a radially inner surface; wherein
the yoke includes:
a yoke cylindrical portion in a cylindrical shape extending in the axial direction; and
a plurality of ridge portions connected to one axial end of the yoke cylindrical portion and arranged at intervals in the circumferential direction;
each of the ridge portions includes:
a protrusion protruding radially inward from the one axial end of the yoke cylindrical portion; and
an extension extending from a radially inner end of the protrusion in another axial direction along a radially inner surface of the yoke cylindrical portion;
each of the plurality of magnets is located between ones of the extensions adjacent to each other in the circumferential direction; and
the plurality of ridge portions are integral with the yoke cylindrical portion to define a single structure.

2. The rotor according to claim 1, wherein another axial end of the extension is located on the other axial direction side with respect to the one axial end of the yoke cylindrical portion, and on one axial direction side with respect to another axial end of the yoke cylindrical portion.

3. The rotor according to claim 1, wherein an axial length of the extension is equal to or larger than one third of an axial width of the yoke cylindrical portion, and is equal to or smaller than the axial width of the yoke cylindrical portion.

4. The rotor according to claim 1, further comprising:
a rotor lid located on the other axial direction side with respect to the ridge portion and expanding in the radial direction; and
a rotor cylindrical portion extending in one axial direction from a radially outer end of the rotor lid; wherein
the rotor cylindrical portion surrounds the yoke cylindrical portion and is in contact with a radially outer surface of the yoke cylindrical portion; and
another axial end of the yoke cylindrical portion is in contact with the rotor lid.

5. The rotor according to claim 1, wherein a radial thickness of the extension is equal to or substantially equal to a radial thickness of the yoke cylindrical portion.

6. The rotor according to claim 1, wherein in at least any one of the ridge portions, a circumferential width of the protrusion is smaller than a circumferential width of the extension.

7. A motor comprising the rotor according to claim 1.

8. A method for manufacturing a rotor that is rotatable about a central axis extending in an axial direction, the rotor including a plurality of extensions extending in the axial direction and arranged side by side at intervals in a circumferential direction with respect to a radially inner surface of a yoke cylindrical portion extending in the axial direction, and a magnet arranged between the plurality of extensions adjacent to each other in the circumferential direction, the method comprising:
forming each of the plurality of extensions by bending each of a plurality of column portions protruding from one axial end of the yoke cylindrical portion and arranged in a circumferential direction at intervals, with a root of the column portion as a fulcrum.

9. The method for manufacturing the rotor according to claim 8, further comprising:
forming a single plate-shaped portion from a plate-shaped magnetic body, the single plate-shaped portion integrally including a disk portion in a disk shape including an opening at a center and the column portions protruding radially inward from an inner edge of the disk portion; and
forming the yoke cylindrical portion by shaping the disk portion into a cylindrical shape extending in a normal direction of the plate-shaped portion by drawing.

10. The method for manufacturing the rotor according to claim 8, further comprising:
forming a single plate-shaped portion from a plate-shaped magnetic body, the single plate-shaped portion integrally including a rectangular or substantially rectangular portion in a plate shape and column portions protruding from one side of an outer edge portion of the rectangular portion; and
forming the yoke cylindrical portion by bending the rectangular or substantially rectangular portion into a cylindrical shape about an axis parallel or substantially parallel to a direction in which the column portions extend.
